(19) United States
(12) Patent Application Publication
(10) Pub. No.: US 2007/0246536 A1
(43) Pub. Date: Oct. 25, 2007

(54) Smartcard Reading/Writing Device, Manufacturing Method Thereof and Method For Contacting A Smartcard

(76) Inventor: Jacobus Nicolaas Tuin, Grasklokje (NL)

Correspondence Address: BARLEY SNYDER, LLC, 1000 WESTLAKES DRIVE, SUITE 275, BERWYN, PA, 19312, US

(21) Appl. No.: 11/737,011

(22) Filed: Apr. 18, 2007

(30) Foreign Application Priority Data
Apr. 24, 2006 (EP) 06008433.2
Apr. 28, 2006 (EP) 06008976.0

(51) Int. Cl. G06K 7/06

(52) U.S. Cl. 235/441

(57) ABSTRACT

A smartcard reading/writing device having a main body with an aperture and a stationary ramp, a sliding contact housing connected to the main body, and a resilient contact disposed the sliding contact housing, wherein upon introduction of a smartcard into the main body, the sliding contact housing is moved along the stationary ramp so that the resilient contact contacts a terminal of the smartcard is disclosed.

### CROSS-REFERENCE TO RELATED APPLICATIONS

This application claims the benefit of the filing date under 35 U.S.C. §119(a)-(d) of EP 06 008 433.2 of Apr. 24, 2006 and EP 06 008 976.0 of Apr. 28, 2006.

### FIELD OF THE INVENTION

The present invention relates to a smartcard reading/writing device, a manufacturing method thereof and a method for contacting a smartcard. Such a smartcard reading/writing device comprises a main body comprising an aperture for introducing a smartcard, a sliding contact housing connected to said main body and comprising resilient contacts for contacting corresponding terminals arranged on the smartcard.

### BACKGROUND

Smartcard reading/writing devices are used for reading/writing data in smartcards such as e.g. credit cards or integrated circuit cards. In conventional smartcard reading/writing devices, resilient contacts contact corresponding terminals arranged on the smartcard. So as to avoid frictions between the terminals of the smartcard and the resilient contacts of the smartcard reading/writing device, landing type resilient contacts are used, i.e. resilient contacts are raised until the smartcard is fully inserted into the smartcard reading/writing device, and then land on the chip card module area, thus preventing scratching the terminals on the smartcard. Indeed, in smartcard reading/writing devices that do not employ landing type resilient contacts, the smartcard wipes over the resilient contacts, thus wearing away the precious metal arranged on the chip card module and then starting wearing the base metal itself, eventually leading to a connector failure.

However, even when using a smartcard reading/writing device with landing type resilient contacts, the resilient contacts wipe over a certain distance on the terminals of the smartcard, said distance being referred to as the wipe length. In conventional smartcard reading/writing devices, even those employing landing type resilient contacts, the wipe length can still be relatively large, thus leading to a limited lifetime of the resilient contacts and a rapid degradation of the terminals of the smartcard.

Furthermore, the conventional IC-card reading/writing devices do not provide for enough protection against mechanical abuse or attack committed with the intention to illegally read or write data from/to the smartcard inserted in the reading/writing device. This is particular problematic in the case where the smartcard is a credit cart that is inserted into a Point-Of-Sale terminal for a payment transaction. The practice has shown that the systems are not secure enough as they are not resistant against a mechanical attack in the form of a hole that is drilled on a front side of the smartcard reader, and in which a wire is introduced so as to create an resilient contact with one of the input/output contacts, in view of tapping the information stream between the smartcard and the paying terminal.

### SUMMARY

The present invention relates to a smartcard reading/writing device having a main body with an aperture and a stationary ramp, a sliding contact housing connected to the main body, and a resilient contact disposed in the sliding contact housing, wherein upon introduction of a smartcard into the main body, the sliding contact housing is moved along the stationary ramp so that the resilient contact contacts a terminal of the smartcard.

### DESCRIPTION OF THE DRAWINGS

Further details, advantages and features of the present invention will become apparent from the following description of an exemplary embodiment together with the drawings, in which:

FIG. 1 is an oblique view of a smartcard reading/writing device according to the present invention mounted to a printed circuit board;

FIG. 2 is another oblique view of the smartcard reading/writing device of FIG. 1 after complete insertion of a smartcard;

FIG. 3 is an oblique view of the smartcard reading/writing device of FIG. 1 that shows its internal structure before insertion of a smartcard;

FIG. 4 is an oblique view of the smartcard reading/writing device of FIG. 1 that shows its internal structure after complete insertion of a smartcard;

FIG. 5 is an oblique view of a smartcard reading/writing device of FIG. 1 before insertion of a smartcard;

FIG. 6 is an oblique view of the smartcard reading/writing device of FIG. 1 after complete insertion of a smartcard;

FIG. 7 is an oblique view of a portion of the smartcard reading/writing device of FIG. 1 showing sliding contact housing arranged on an introduced smartcard before a complete introduction of the smartcard into the smartcard reading/writing device;

FIG. 8 is an oblique view of a portion of the smartcard reading/writing device of FIG. 1 showing complete introduction of the smartcard into the smartcard reading/writing device;

FIG. 9 is an oblique view of a cross-section through the sliding contact housing of FIG. 7;

FIG. 10 is an oblique view of a cross-section through the sliding contact housing of FIG. 7 during introduction of a smartcard;

FIG. 11 is an oblique view of a cross-section through the sliding contact housing of FIG. 7 upon introduction of the smartcard until a pre-contacting position;

FIG. 12 is an oblique view of a cross-section through the sliding contact housing of FIG. 7 after a complete introduction of the smartcard into the smartcard reading/writing device of FIG. 1;

FIG. 13 is an oblique view of the smartcard reading/writing device of FIG. 1 as assembled with a cover according to the present invention;

FIG. 14 is an oblique view of the smartcard reading/writing device shown in FIG. 13 without its main body;

FIG. 15 is an oblique view of the smartcard reading/writing device shown in FIG. 13;

FIG. 16 is an oblique view of a front side of the smartcard reading/writing device of FIG. 1;

FIG. 17 is an oblique view of a cross-section through the smartcard reading/writing of FIG. 1; and

FIG. 18 is an oblique view of a smartcard reading/writing device of FIG. 1 showing the bottom side of the sliding contact housing.

### DETAILED DESCRIPTION OF THE EMBODIMENT(S)

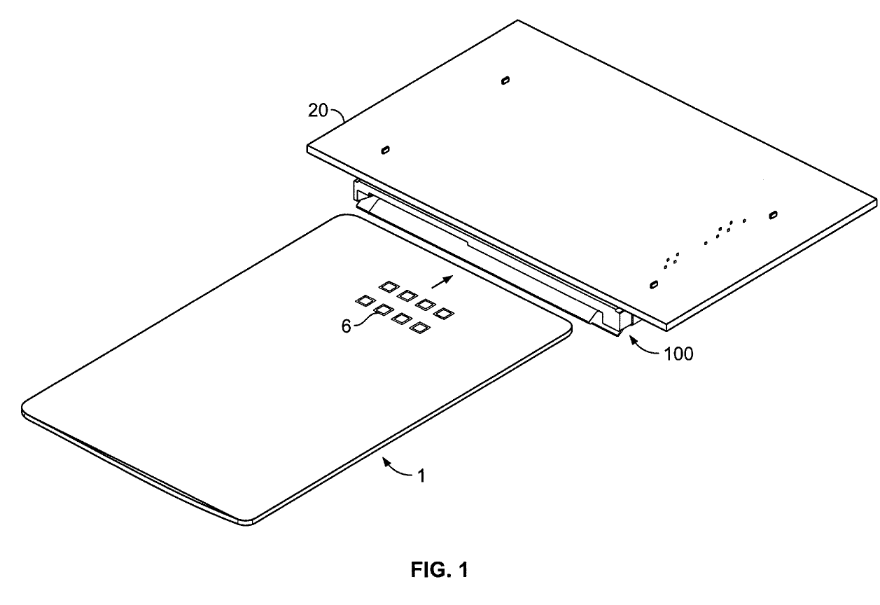

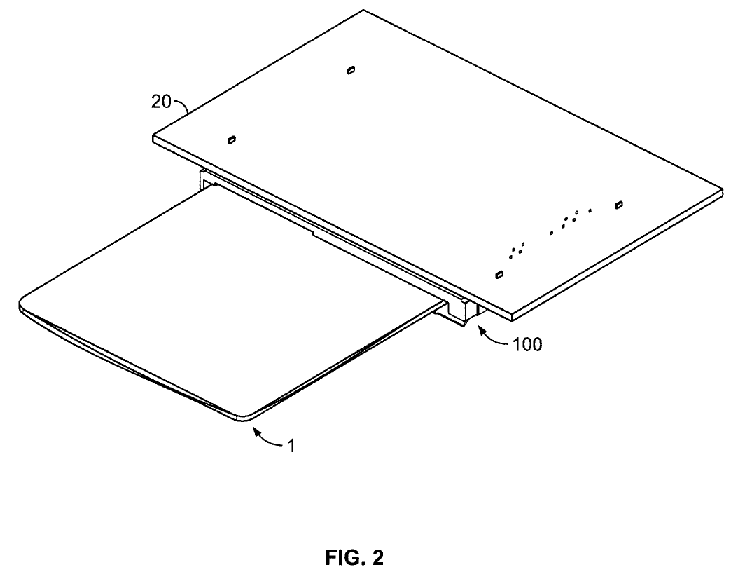

FIG. 1 is an oblique view of a smartcard reading/writing device 100 that is mounted with a printed circuit board 20, and shown before a smartcard 1 is introduced into the smartcard reading/writing device 100. The smartcard 1 comprises terminals 6 arranged on its upper surface that are read by resilient contacts 5 of the smartcard reading/writing device 100. FIG. 2 is an oblique view of the smartcard reading/writing device 100 with the smartcard 1 introduced therein.

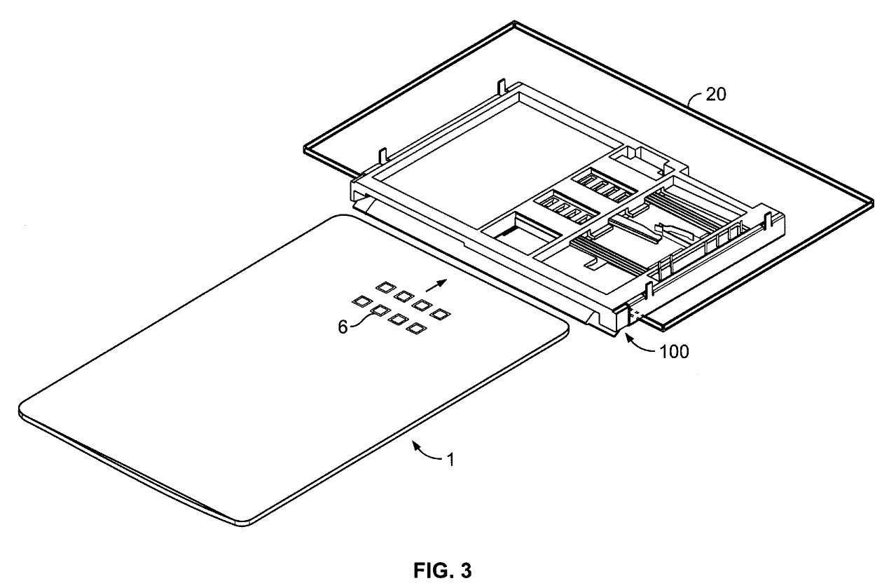

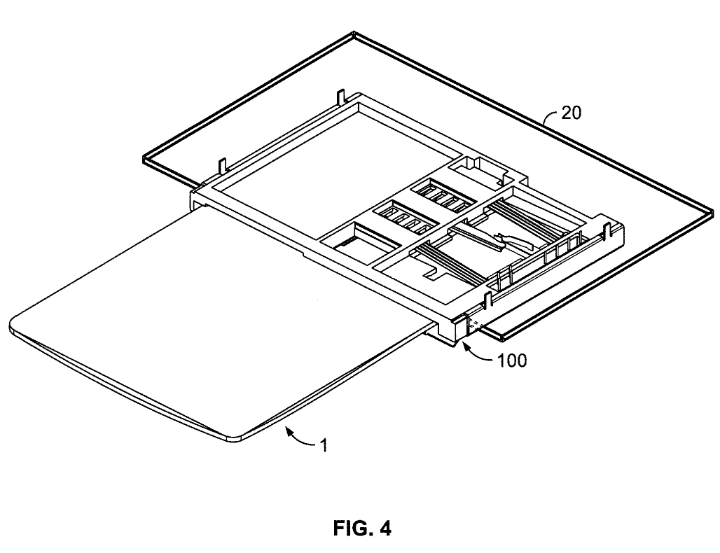

FIG. 3 is an oblique view showing the internal structure of the smartcard reading/writing device 100 according to one embodiment of the invention, before a smartcard 1 has been introduced therein. FIG. 4 is an oblique view of the smartcard reading/writing device 100 showing the internal structure of the smartcard reading/writing device 100 when the smartcard 1 has been introduced therein.

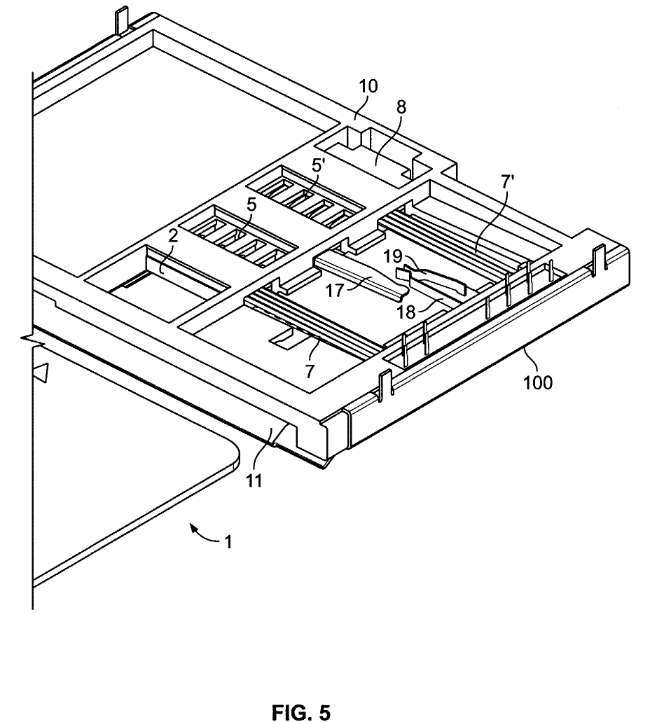

FIG. 5 is an oblique view of a smartcard reading/writing device 100 according to an embodiment of the invention, when the smartcard reading/writing device 100 is not mounted with a printed circuit board. The smartcard reading/writing device 100 comprises a main body 10 comprising an aperture 11 for introducing a smartcard 1. The smartcard reading/writing device 100 further comprises a sliding contact housing 2 that is connected to the main body 10. The sliding contact housing 2 comprises resilient contacts 5, 5′ for contacting the corresponding terminals of the smartcard 1. It is may be advantageous to over-mold the resilient contacts 5, 5′ in the sliding contact housing 2, so as to produce the sliding contact housing 2 in a cost effective manner. The resilient contacts 5, 5′ of the sliding contact housing 2 are elongated by corresponding flexible leads 7, 7′ that extend across the main body 10 essentially perpendicularly to the direction of introduction of the smartcard 1 into the main body 10. The flexible leads 7, 7′ are over-molded and then mounted in the main body 10, so that they protrude from the main body 10 for mounting on a printed circuit board (not shown in this figure). The sliding contact housing 2 further comprises an arm 17 that protrudes from the sliding contact housing 2 and whose end is positioned in the vicinity of a first switch element 18 without contacting it, said first switch element 18 being an over-molded part that is arranged on the main body 10. A second switch element 19 is arranged on the main body 10 next to the first switch element 18. The first switch element 18 and the second switch element 19 form a switch that is closed when the smartcard 1 is fully introduced into the smartcard reading/writing device 100.

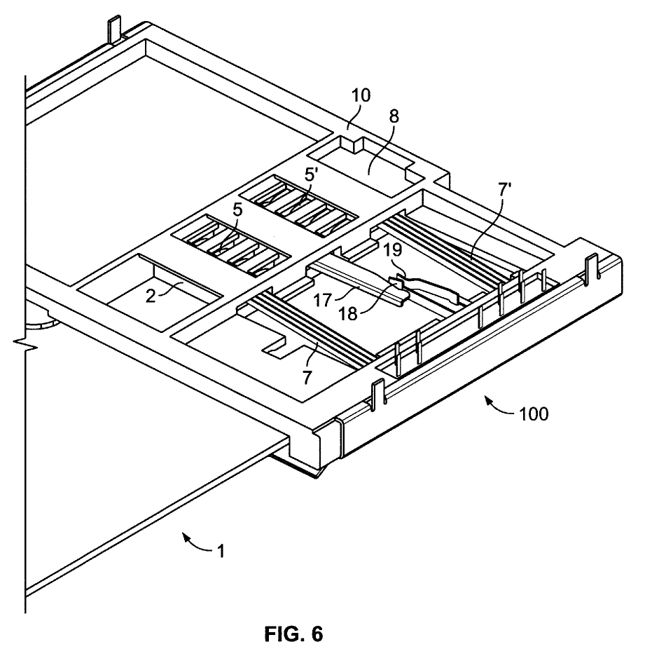

FIG. 6 shows an oblique view of the smartcard reading/writing device 100 when the smartcard 1 is introduced completely therein. Upon introduction of the smartcard 1 into the main body 10 of the smartcard reading/writing device 100, the sliding contact housing 2 is moved along the direction of introduction of the smartcard 1. The flexible leads 7 are arranged in such a way that the sliding contact housing 2 is movable with respect to the fixed main body 10 of the smartcard reading/writing device 100. In comparison with FIG. 5, the sliding contact housing 2 is shown in FIG. 6 in a shifted position with respect to the direction of introduction of the smartcard 1 into the main body 10. A stopping end 8 of the sliding contact housing 2 is shown in FIG. 6 to be in contact with the main body 10, whereas in FIG. 5 the stopping end 8 of the sliding contact housing 2 and the main body 10 were spaced from each other.

Upon a complete introduction of the smartcard 1 into the smartcard reading/writing device 100, the arm 17 is moved into contact with the first switch element 18. By contacting the first switch element 18, the arm 17 forces the first switch element 18 into contact with the second switch element 19, thus closing the switch and indicating that the smartcard 1 has been completely introduced into the smartcard reading/writing device.

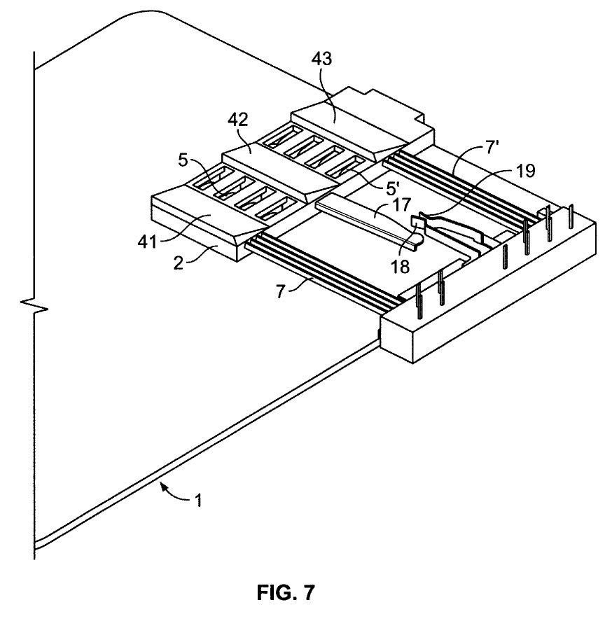

FIG. 7 is an oblique view showing the sliding contact housing 2 in a pre-contacting position, where the resilient contacts 5, 5′ of the sliding contact housing 2 are located in a vicinity of the corresponding terminals 6 of the smartcard 1 without contacting them. The sliding contact housing 2 comprises first sliding ramp 41, second sliding ramp 42, and third sliding ramp 43 that can be moved along corresponding first stationary ramp 31, second stationary ramp 32, and third stationary ramp 33 (not shown) of the main body 10 to enable contacting between the resilient contacts 5, 5′ and the terminals 6 of the smartcard 1, thus landing the resilient contacts 5, 5′ on the terminals 6 with a reduced wipe length. The second sliding ramp 42 is arranged between the first and third sliding ramps 41, 43 that are arranged on both sides of the sliding contact housing 2. The first sliding ramp 41, second sliding ramp 42, and third sliding ramp 43 of the sliding contact housing 2 may be planar surfaces that are sloped at an angle with respect to the main plane of the sliding contact housing 2. Sliding ramps 41, 42, and 43 may be sloped at the same or substantially the same angle as stationary ramps 31, 32, and 33.

Even though the figures enclosed with this application only show the first sliding ramp 41, second sliding ramp 42, and third sliding ramp 43 being planar sloped surfaces, other surface shapes, such as slightly convex surfaces, may be considered, as long as the chosen surface shape allows for an easy translation movement of the sliding contact housing 2 with respect to the main body 10. Furthermore, even though the particular example of three surfaces being arranged on the sliding contact housing 2 is described in this application, alternative embodiments may comprise only one surface on the sliding contact housing 2 that is adapted to be moved along a corresponding surface of the main body 10. In fact, an arbitrary number of surfaces or ramps that are adapted to be moved along corresponding surfaces of the main body 10 may be incorporated on the sliding contact housing 2.

The resilient contacts are arranged in two sets 5, 5′ that are provided in two corresponding sets of slots respectively between the first sliding ramp 41 and the second sliding ramp 42, and between the second sliding ramp 42 and the third sliding ramp 43 of the sliding contact housing 2. The arrangement of the resilient contacts 5, 5′ corresponds to an arrangement of the terminals 6 on the smartcard 1.

Even though the particular example of two sets 5, 5′ of resilient contacts being respectively between a first sliding ramp 41 and a second sliding ramp 42, and between the second sliding ramp 42 and a third sliding ramp 43 of the sliding contact housing 2 is described in this application, other arrangements may also be considered. For instance, the two sets of resilient contacts may also be provided between two surfaces of the sliding contact housing 2 that are arranged on both sides thereof. Other arrangements will be apparent to those skilled in the art.

The two sets of resilient contacts 5, 5′ are elongated by two corresponding sets of flexible leads 7, 7′ that extend across the main body 10 essentially perpendicularly to a direction of introduction of the smartcard 1 into the main body 10. The two sets of corresponding flexible leads 7, 7′ are over-molded parts mounted in the main body 10 so that they protrude from the main body 10 for mounting on a printed circuit board (not shown). The flexible leads 7, 7′ are arranged in such a way that the sliding contact housing 2 is movable along surfaces corresponding to the first sliding ramp 41, second sliding ramp 42, and third sliding ramp 43 of the sliding contact housing 2. In case the ramps 41, 42, 43 of the sliding contact housing 2 are illustrated as planar surfaces sloped at an angle with a main plane of the sliding contact housing 2, the flexible leads 7, 7′ are oriented essentially perpendicularly to the plane of the ramps 41, 42, 43. The ramps 41, 42, 43 of the sliding contact housing 2 are thus easily movable along the plane of the ramps 41, 42, 43 since the flexible leads 7, 7′ are oriented to facilitate a flexible movement along this plane. When the flexible leads 7, 7′ are chosen to have e.g. a rectangular section, it is particularly advantageous to orientate an axis of the wider section of the flexible leads 7, 7′ essentially perpendicularly to the surface of the main body 10, as the flexible leads 7, 7′ are more flexible along the surface of the main body 10 with such an orientation in comparison with the situation where the axis of the wider section is oriented parallel to the surface of the main body 10.

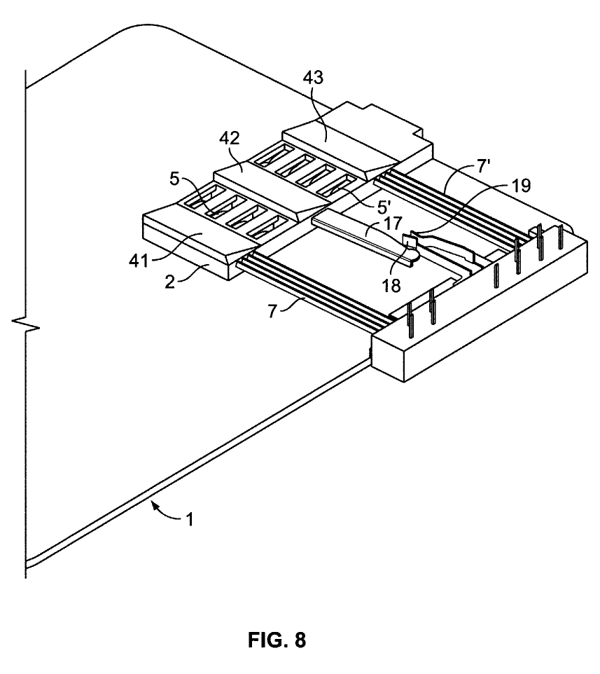

FIG. 8 is an oblique view of the sliding contact housing 2 in a contacting position, where the resilient contacts 5, 5′ contact the corresponding terminals 6 of the smartcard 1. It shows the sliding contact housing 2 after its ramps 41, 42, 43 have moved along corresponding first, second, and third stationary ramps 31, 32, 33 of the main body 10 (not shown). When moving from the pre-contacting position shown in FIG. 7 to the contacting position shown in FIG. 8, the sliding contact housing 2 is moved downward in the direction of the smartcard 1 and forward in the direction of introduction of the smartcard 1, this composite movement being performed along the planes of the sliding ramps 41, 42, 43 of the sliding contact housing 2.

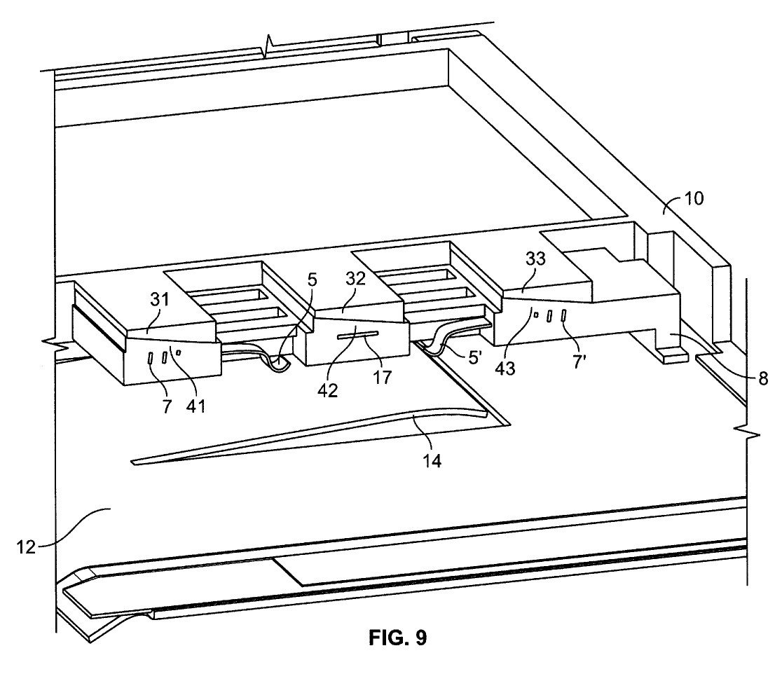

FIG. 9 is an oblique view of a cross-section through a smartcard reading/writing device 100 according to an embodiment of the invention. The main body 10 comprises first stationary ramp 31, second stationary ramp 32, and third stationary ramp 33 that correspond respectively to first sliding ramp 41, second sliding ramp 42, and third sliding ramp 43 of the sliding contact housing 2. The stationary ramps 31, 32, 33 of the main body 10 are adapted to be moved along the corresponding sliding ramps 41, 42, 43 of the sliding contact housing 2. The sliding contact housing 2 comprises a stopping end 8 shown on the right-hand side of FIG. 9. Since no smartcard 1 is inserted into the smartcard reading/writing device 100 in FIG. 9, the stopping end 8 of the sliding contact housing 2 is separated from the main body 10 by a spacing. FIG. 9 also shows cross-sections of the flexible leads 7, 7′ that elongate the respective resilient contacts 5, 5′ and that are embedded within the sliding contact housing 2. It also shows a cross-section of the arm 17 that is embedded within the sliding contact housing 2.

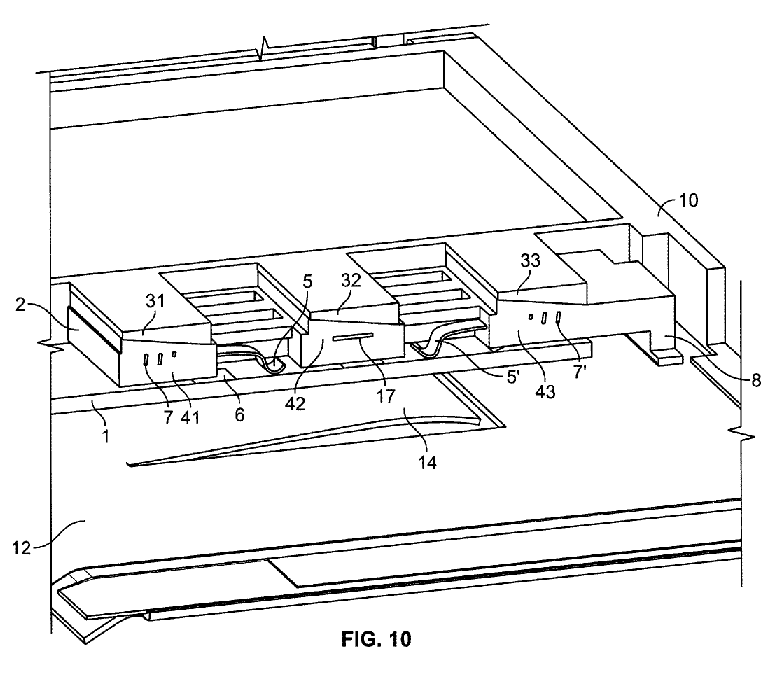

FIG. 10 is an oblique view corresponding to the one shown in FIG. 9, wherein a smartcard 1 is partially inserted into the smartcard reading/writing device 100. The smartcard 1 is introduced into the main body 10 between the sliding contact housing 2 and a supporting surface 12 for supporting the introduced smartcard 1. A resilient support 14, such as a spring, is illustrated in the supporting surface 12, which pushes the introduced smartcard 1 towards the sliding contact housing 2. As the smartcard 1 is only partially inserted, there is some play between the sliding contact housing 2 and the introduced smartcard 1, as well as between the resilient contacts 5, 5′ and the smartcard 1.

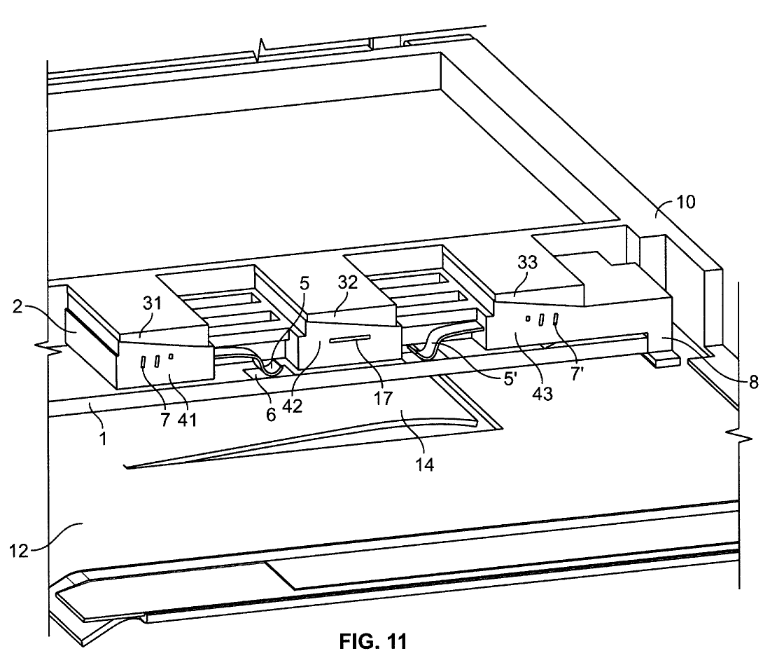

FIG. 11 shows an oblique view of a cross-section of the smartcard reading/writing device 100 corresponding to FIGS. 9 and 10, wherein the smartcard 1 is introduced into the main body 10 until the forward edge of the smartcard 1 has reached a stopping end 8 of the sliding contact housing 2. The smartcard 1 is still partially inserted into the main body 10 of the smartcard reading/writing device 100 as there is a spacing between the stopping end 8 of the sliding contact housing 2 and the main body 10. Further, there is still a spacing between the smartcard 1 and the sliding contact housing 2 as well as between the resilient contacts 5, 5′ and the terminals 6 of the smartcard 1.

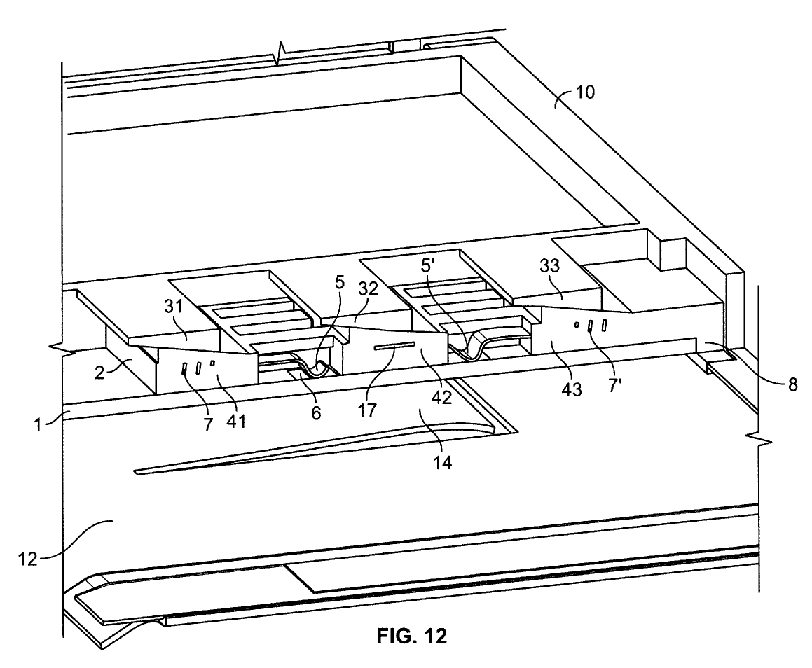

FIG. 12 is an oblique view of a cross-section of the smartcard reading/writing device 100 corresponding to FIGS. 9, 10, and 11, wherein the smartcard 1 is completely inserted into the main body 10 of the smartcard reading/writing device 100. It shows that the sliding contact housing 2 has moved with respect to the main body 10 from the pre-contacting position shown in FIG. 11 to a contacting position, where the resilient contacts 5, 5′ contact the corresponding terminals 6 of the smartcard 1 and the smartcard 1 is in direct contact with the sliding contact housing 2, i.e. there is no play between them anymore. To move from the pre-contacting position to the contacting position, the sliding ramps 41, 42, 43 of the sliding contact housing 2 are moved along the corresponding stationary ramps 31, 32, 33 of the main body 10, thereby causing the sliding contact housing 2 to move downwards towards the introduced smartcard 1 and forward until the end of the sliding contact housing 2 is in contact with the main body 10.

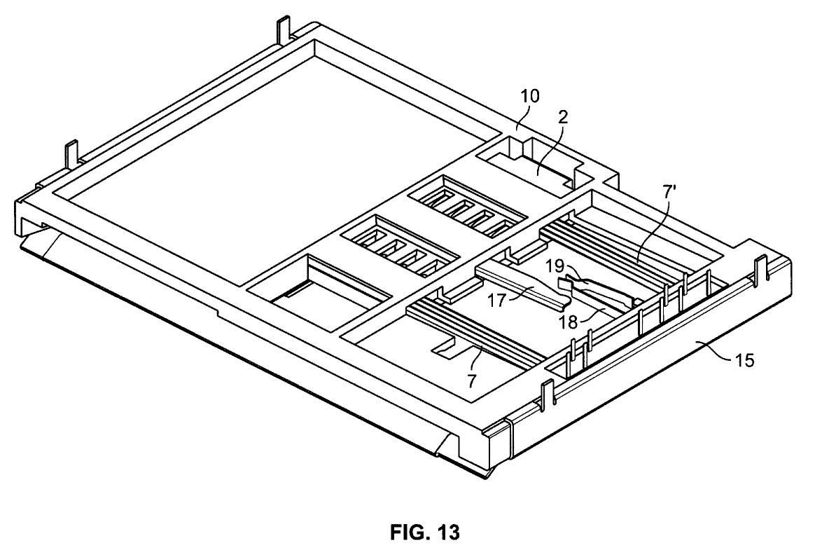

FIG. 13 shows an oblique view of the smartcard reading/writing device 100 according to an embodiment of the invention. The main body 10 of the smartcard reading/writing device 100 is mounted in a cover 15.

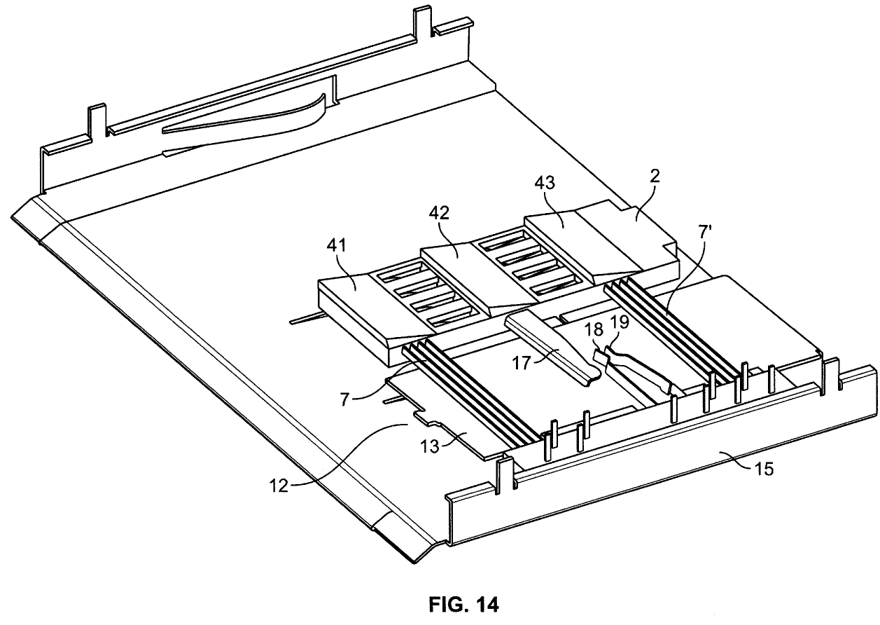

FIG. 14 shows an oblique view of the smartcard reading/writing device 100, wherein the main body 10 has been removed. It shows a shielding plate 13 that is arranged parallel to the supporting surface 12. The shielding plate 13 is arranged so that the flexible leads 7, 7′ are enclosed between the shielding plate 13, the main body 10 and the printed circuit board 20 in a mounted position of the smartcard reading/writing device 100. The shielding plate 13 thus allows for protecting the flexible leads 7 from mechanical attacks with the purpose of tapping information streams carried by the flexible leads 7, 7′. Even if a hole is drilled on the front side of the smartcard reading/writing device 100 and a wire is introduced with the purpose of tapping the signals carried by the flexible leads 7, 7′, only an exterior flexible lead 7, that is closer to the front side of the smartcard reading/writing device 100, is accessible. Since such flexible lead 7, according to the international specifications, is not meant to carry input/output signals, an intruder would therefore not be able to tap input/output information streams, thus making the smartcard reading/writing device 100 secure. Even though the shielding plate 13 is described as a metal plate being an element that is separate from the main body 10, the shielding plate 13 may alternatively be formed as a plastic part that is an integral part of the main body 10.

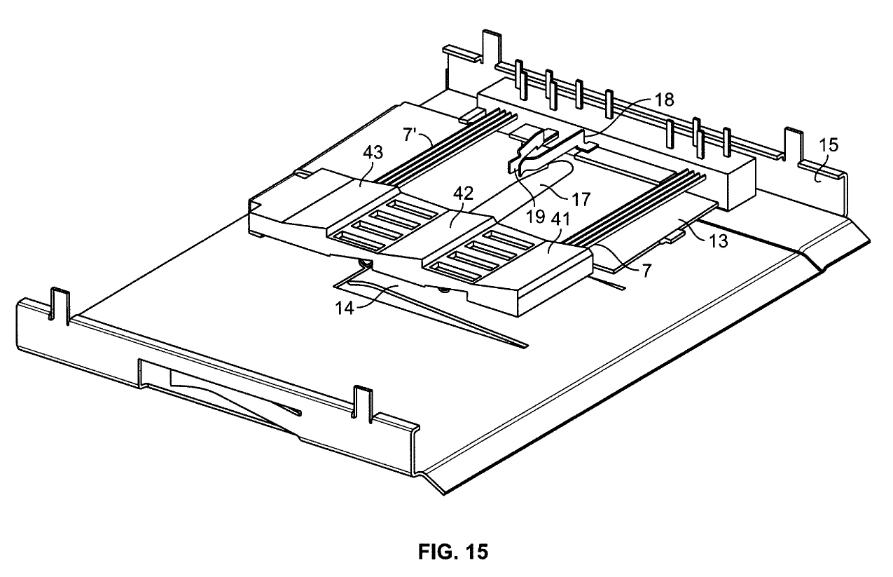

FIG. 15 shows another oblique view of the smartcard reading/writing device 100 shown in FIG. 14.

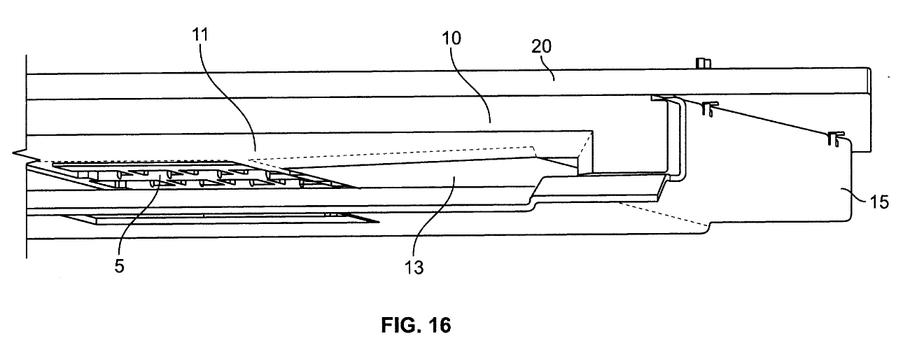

FIG. 16 shows an oblique view from the front side of the smartcard reading/writing device 100 that is mounted on a printed circuit board 20.

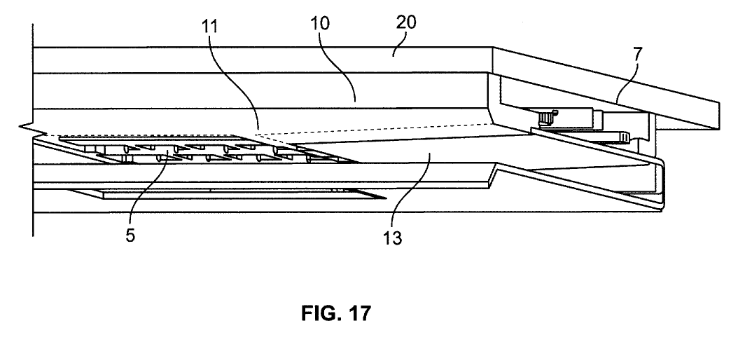

FIG. 17 shows an oblique view of a cross-section through the smartcard reading/writing device 100 shown in FIG. 16. It shows that the flexible leads 7, 7′ are completely enclosed between the shielding plate 13, the main body 10, and the printed circuit board 20.

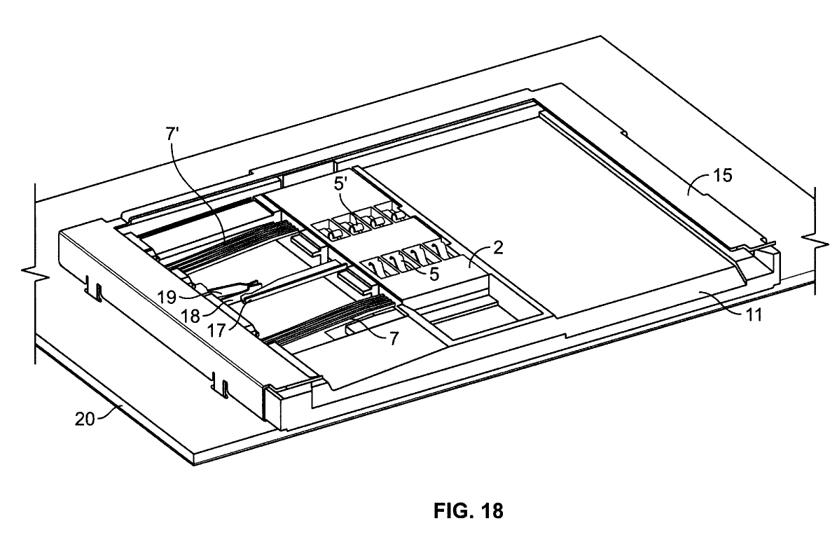

FIG. 18 is an oblique view of a smartcard reading/writing device 100 according to an embodiment of the invention, wherein the cover 15 has been partially removed. The oblique view shows the bottom side of the smartcard reading/writing device 100, thus unveiling the bottom side of the sliding contact housing 2. It shows the resilient contacts 5, 5′ that are meant to contact the terminals 6 of a smartcard 1 introduced into the smartcard reading/writing device 100.

A method for contacting a smartcard 1 to the smartcard reading/writing device 100 comprises the steps of introducing a smartcard 1 through an aperture 11 formed in a main body 10 of the smartcard reading/writing device 100, and moving a sliding contact housing 2 along a surface 41, 42, 43 of said main body upon introduction of the smartcard 1 into the main body 10, thereby contacting resilient contacts 5, 5′ arranged on the sliding contact housing 2 with corresponding terminals 6 arranged on the smartcard 1.

Since the sliding contact housing 2 is adapted to be moved along a surface 12 of the main body 10 upon introduction of the smartcard 1 into the main body 10 so that said resilient contacts 5, 5′ contact said corresponding terminals 6 arranged on the smartcard 1, a very flexible connection can be established between the sliding contact housing 2 supporting the resilient contacts 5, 5′ and the main body 10, which is a fixed element. The wipe length can thus be reduced to a very small distance, as small as 0.1 millimeter or even smaller. This allows for reducing the friction between the resilient contacts 5, 5′ and the corresponding terminals 6 arranged on the smartcard 1 and thus leads to an improved durability of the resilient contacts 5, 5′. The number of mating cycles can thus be increased.

The foregoing illustrates only some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A smartcard reading/writing device, comprising:
a main body having an aperture and a stationary ramp;
a sliding contact housing connected to the main body; and
a resilient contact disposed in the sliding contact housing;
wherein upon introduction of a smartcard into the main body, the sliding contact housing is moved along the stationary ramp so that the resilient contact contacts a terminal of the smartcard.

2. The smartcard reading/writing device according to claim 1, wherein the sliding contact housing comprises:
a sliding ramp configured to move along the stationary ramp.

3. The smartcard reading/writing device according to claim 2, wherein the stationary ramp and the sliding ramp are sloped at substantially the same angle.

4. The smartcard reading/writing device according to claim 1, wherein the sliding contact housing further comprises:
a stopping end which stops introduction of the smartcard, thereby positioning the smartcard in a pre-contacting position where the resilient contact is near the terminal but not contacting the terminal.

5. The smartcard reading/writing device according to claim 4, wherein the sliding contact housing is configured for movement along the stationary ramp from the pre-contacting position to a contacting position where the resilient contact contacts the terminal.

6. The smartcard reading/writing device according to claim 1, wherein the resilient contact is over-molded in the sliding contact housing.

7. The smartcard reading/writing device according to claim 1, wherein the resilient contact is elongated by a flexible lead.

8. The smartcard reading/writing device according to claim 7, wherein the flexible lead is configured so that the sliding contact housing is movable along the stationary ramp.

9. The smartcard reading/writing device according to claim 7, wherein the flexible lead is oriented with respect to a plane of the stationary ramp so that a most flexible direction for bending the flexible lead is along a moving direction of the sliding contact housing.

10. The smartcard reading/writing device according to claim 7, further comprising
a shielding plate oriented substantially parallel to a supporting surface;
wherein the flexible lead is substantially enclosed between the shielding plate, the supporting surface, and a printed circuit board.

11. The smartcard reading/writing device according to claim 1, further comprising:
a plurality of resilient contacts arranged in two sets corresponding to an arrangement of a plurality of terminals; and
a plurality of sliding ramps corresponding to a plurality of stationary ramps.

12. The smartcard reading/writing device according to claim 11, wherein a second sliding ramp is arranged between a first sliding ramp and a third sliding ramp and wherein each of the sliding ramps correspond to one of three stationary ramps.

13. The smartcard reading/writing device according to claim 11, wherein the two sets of resilient contacts are elongated by two sets of corresponding flexible leads.

14. The smartcard reading/writing device according to claim 13, wherein the two sets of flexible leads are oriented with respect to a plane of the stationary ramps so that a most flexible direction for bending the two sets of flexible leads is along a moving direction of the sliding contact housing.

15. The smartcard reading/writing device according to claim 1, further comprising:
a support surface for supporting the smartcard; and
a resilient support arranged on the support surface for pushing the smartcard against the sliding contact housing.

16. A method of manufacturing a smartcard reading/writing device, the method comprising the steps of:
forming an aperture in a main body for introducing a smartcard;
forming a sliding contact housing having a resilient contact for contacting a corresponding terminal of the smartcard; and
connecting the sliding contact housing to the main body;
wherein the sliding contact housing is formed so that the sliding contact housing is movable along a stationary ramp of the main body so that the resilient contact contacts the terminal.

17. A method of contacting a smartcard in a smartcard reading/writing device, the method comprising the steps of:
introducing a smartcard through an aperture formed in a main body of the smartcard reading/writing device; and
moving a sliding contact housing along a stationary ramp of the main body causing a resilient contact carried by the sliding contact housing to contact a corresponding terminal of the smartcard.
